(19) United States
(12) Patent Application Publication
(10) Pub. No.: US 2024/0359364 A1
(43) Pub. Date: Oct. 31, 2024

(54) PROCESS FOR PRODUCING CONCENTRATES OF NATURAL AND/OR SYNTHETIC AND/OR MAN-MADE FIBRES IN POLYMER MATRICES IN THE FORM OF GRANULES

(71) Applicant: DE MARTINI S.P.A., Cerrione (IT)

(72) Inventors: Daniele BONACCHI, PISTOIA (IT); Emiliano FERRONI, Serravalle Pistoiese (IT)

(73) Assignee: DE MARTINI S.P.A., Cerrione, BIELLA (IT)

(21) Appl. No.: 18/291,291

(22) PCT Filed: Jul. 22, 2022
(86) PCT No.: PCT/IB2022/056800

§ 371 Date: Jan. 23, 2024

(30) Foreign Application Priority Data
Jul. 23, 2021 (IT) 102021000019670

(51) Int. Cl. B29B 9/06; B29B 9/14; C08J 3/12; C08J 5/04

(52) U.S. Cl. CPC B29B 9/06; B29B 9/14; C08J 3/12; C08J 5/045; C08J 5/046; C08J 5/048; C08J 2367/04

(57) ABSTRACT

The present invention relates to a process for producing granules comprising discontinuous fibres. Said granules have characteristics of a residual moisture ≤6% and final apparent density ≥0.10 g/cm³, making them suitable for use as additives in traditional thermoplastic production processes. The present invention further relates to a fibre-reinforced composite plastic material obtainable by adding said granules during the plastic production process.

### FIELD OF THE INVENTION

The present invention fits into the plastic production sector, more specifically, the production of fibre-reinforced plastic. The present invention relates to a process for producing granules comprising discontinuous fibres that have residual moisture and density characteristics making them suitable for use as additives in traditional plastic production processes.

### STATE OF THE ART

The use of fibres obtained by cutting continuous fibres as additives within plastic is widely known. In particular, one may mention the use of glass and/or carbon fibres, which are added to the plastic during the process of formation thereof. In thermoplastic processes, both types of fibres are added in the form of granules containing a plurality of fibres oriented unidirectionally and joined together by a matrix generally added by means of a pultrusion process. The above-mentioned fibres are, as already noted, continuous fibres that are subsequently cut according to the desired granule size.

In recent years, increasing attention has been focused on fibres of natural origin (hemp, flax, bamboo etc.) as possible eco-sustainable alternatives to the above-mentioned fibres. However, though their effectiveness has been ascertained both from the standpoint of structural reinforcement and from the standpoint of the sustainability of the products containing them, this type of fibres still poses numerous problems from the standpoint of industrial processability. Fibres of natural origin (or “natural fibres”) are in fact discontinuous fibres, which are difficult to integrate into an industrial plastic production process of the traditional type due to two main factors: their low density and their ability to absorb and retain moisture (hygroscopicity). Though the first problem can be obviated through the use of specific dosing machinery, the removal of moisture, however, proves to be an extremely difficult operation, if not even an impossible one in some cases. The residual moisture deriving from the introduction of such fibres into the plastic is extremely undesirable since, especially in the case of polyester plastics like PLA or PET, it damages and irreparably degrades the plastic itself.

It thus appears clear that, at the current state of the art, in the plastics industry, a satisfactory alternative to traditional continuous glass and/or carbon fibres is yet to be found.

The present invention solves the above-described problems by providing a process for producing a granule comprising discontinuous fibres, such as natural fibres, which by virtue of its specific process has an extremely reduced residual moisture and/or an apparent density suitable for it to be added in traditional thermoplastic forming processes. The present invention also provides, therefore, a process for producing a plastic reinforced by discontinuous fibres such as natural fibres without the drawbacks tied to the residual moisture and low density typical of said fibres and the consequent degradation of the plastic itself.

### SUMMARY OF THE INVENTION

The present invention relates to a process for producing granules comprising discontinuous fibres in a polymer matrix, wherein said polymer matrix derives from the fusion of sacrificial polymeric fibres.

More specifically, the process according to the present invention comprises a step in which discontinuous natural or high-melting fibres (hereinafter “discontinuous fibres”) and low-melting discontinuous polymeric fibres (hereinafter “polymeric fibres”, also called sacrificial fibres), in a mixture with each other, are subjected to carding until a non-woven fabric or a sliver is obtained, which is subsequently condensed at a controlled temperature in order to form a cord or subjected to twisting to obtain the cord. The cord is then cut into granules of the desired size.

The sliver is obtained by passing the non-woven fabric through a funnel applied to the carding machine.

According to an alternative embodiment of the present invention, said polymeric fibres are replaced with at least one binder. According to that embodiment, the process according to the present invention comprises a step in which said discontinuous fibres are subjected to carding until a non-woven fabric or a sliver is obtained; it is subsequently treated with a binder according to a hot or cold spray coating, dip coating and/or moulding technique and subsequently condensed or subjected to a twisting process at a controlled temperature in order to form a cord, which is then cut into granules of the desired size. The granules thus obtained, according to any one of the embodiments of the present invention, are characterized by having a residual moisture ≤6% and an apparent density ≥0.10 g/cm³, making them suitable for use in traditional plastic production processes as additives for producing fibre-reinforced composite plastic materials.

The present invention further relates to a fibre-reinforced composite plastic material obtainable by adding the aforesaid granules inside an extruder or an injection moulding machine comprising the polymers to be processed until a composite plastic material comprising, dispersed therein, said discontinuous fibres is obtained. According to the embodiment wherein the granules comprise discontinuous fibres in a polymer matrix, said polymer matrix of the granules and polymers used to produce the plastic material are preferably the same material and said polymer matrix is perfectly fused and indistinguishable within the final fibre-reinforced composite plastic material.

### DETAILED DESCRIPTION OF THE INVENTION

For the purposes of the present invention, the expression “discontinuous fibres” refers to fibres whose length is less than 15 centimetres, typically less than 60 mm, to be distinguished from so-called continuous fibres characterised by a single filament at least several tens of centimetres long, more typically several tens of metres long.

For the purposes of the present invention, the expression “granules comprising discontinuous fibres in a polymer matrix” is to be understood as synonymous of “concentrates of discontinuous fibres in a polymer matrix”.

For the purposes of the present invention the “polymeric fibres” comprised in the mixture of fibres of step (i) of the process according to the present invention are to be understood as “sacrificial fibres”, i.e. fibres that lose their shape.

For the purposes of the present invention, “apparent density” means the density of a body calculated in a similar manner to absolute density, but taking into consideration the total volume occupied by the solid, i.e. its overall outer dimensions, including, therefore, the empty spaces (solids with closed cavities, open cavities or a spongy structure). The definition of apparent density applies for granular matter contained in receptacles such as, for example, sand and grains or soil.

For the purposes of the present invention, “traditional plastic production processes” means (thermoplastic) extrusion and injection moulding processes.

The present invention relates to a process for producing granules comprising discontinuous fibres in a polymer matrix.

Said process comprises the steps of:
(i) Providing a mixture of discontinuous fibres and polymeric fibres;
(ii) Subjecting said discontinuous fibres and said polymeric fibres to a carding process until a non-woven fabric or a sliver is obtained;
(iii) Subjecting said non-woven fabric or said sliver to heat treatment;
(iv) Subjecting said non-woven fabric or said sliver obtained after step (iii) to a condensation process wherein said non-woven fabric is conveyed inside a temperature controlled funnel at the exit of which it is pressed inside a template, preferably having a cylindrical or rectangular shape, to a form a cord or said non-woven fabric or said sliver is subjected to twisting to form a cord;
(v) Cutting said cord obtained after step (iv) into granules.

According to an alternative embodiment of the present invention, said polymer matrix and said polymeric fibres are replaced with at least one binder selected from the group consisting of: vegetable waxes, animal waxes, mineral waxes, polyvinyl alcohol (PVA), cellulose acetate, vinyl acetate, ethyl cellulose, ethylvinyl alcohol, starch, casein, animal gelatine, egg white, egg yolk, bitumen, solid terpenes, and a combination thereof. According to that embodiment, the process according to the present invention comprises the steps of:
(i′) Providing discontinuous fibres;
(ii′) Subjecting said discontinuous fibres to a carding process until a non-woven fabric or a sliver is obtained;
(iii′) Treating said non-woven fabric obtained in step (ii′) with at least one binder as described above by means of a spray coating, dip coating and/or moulding technique;
(iv′) Subjecting said non-woven fabric or said sliver to heat treatment;
(v′) Subjecting said non-woven fabric or said sliver obtained after step (iv′) to a condensation process wherein said non-woven fabric or sliver is conveyed inside a temperature controlled funnel at the exit of which it is pressed inside a template, preferably having a cylindrical or rectangular shape, to form a cord or subjecting said non-woven fabric or said sliver to a twisting step to obtain a cord;
(vi′) Cutting said cord obtained after step (v′) in granules.

According to another alternative embodiment of the present invention, the condensation or twisting step (v′) can be carried out between steps (ii′) and (iii′). In other words, according to that embodiment, said condensation step (v′) is a step of subjecting said non-woven fabric or sliver obtained in step (ii′) to a condensation process wherein said non-woven fabric is conveyed inside a temperature controlled funnel at the exit of which it is pressed inside a template, preferably having a cylindrical or rectangular shape, to form a cord, or said non-woven fabric or sliver is subjected to a twisting step to form a cord. According to that embodiment, therefore, step (iii′) is a step of treating said cord (obtained after step (v′)) with at least one binder as described above by means of a spray coating, dip coating and/or moulding technique, step (iv′) is a step of subjecting said cord to heat treatment and step (vi′) is a step of cutting said cord (obtained after step (iv′)) into granules.

Preferably, said granules obtained in step (v) or step (vi′) have:
the dimension of the major axis between 5 and 40 mm, preferably between 10 and 20 mm, more preferably about 15 mm;
the dimension of the section between 1 and 20 mm, preferably between 2 and 6 mm, more preferably about 4 mm; and
the dimension of the height between 0.5 and 10 mm, preferably between 1 and 5 mm, more preferably about 4 mm.

According to a particularly preferred embodiment, said granules have the shape of parallelepipeds.

According to one embodiment of the present invention, the mixture of discontinuous fibres and polymeric fibres of step (i) or the non-woven fabric treated with at least one binder of step (iii′) described above, comprises said discontinuous fibres in an amount ≥50% by weight, preferably in an amount between 50 and 99% by weight, more preferably between 60 and 80% by weight.

According to one embodiment of the present invention, the mixture of discontinuous fibres and polymeric fibres of step (i) described above comprises said polymeric fibres in an amount ≤50% by weight, preferably in an amount between 5 and 50% by weight, more preferably between 20 and 40% by weight.

According to one embodiment, in step (ii) or (ii′) the sliver is obtained by conveying the non-woven fabric into a funnel applied on the carding machine.

According to an alternative embodiment of the present invention, the non-woven fabric treated with at least one binder of step (iii′) described above comprises said at least one binder in an amount between 1 and 30%, preferably between 2 and 20%, more preferably between 5 and 10%. In other words, in step (iii′) described above, according to one embodiment of the present invention, said at least one binder is used to treat the non-woven fabric in an amount between 1 and 30%, preferably between 2 and 20%, more preferably between 5 and 10%.

Preferably, according to any one of the embodiments of the present invention, said discontinuous fibres are selected from the group consisting of: fibres of natural origin selected from the group consisting of: cotton, hemp, bamboo, linen, coconut and a combination thereof, and/or synthetic fibres selected from the group consisting of: fibres of polypropylene, polyethylene, polyethylene terephthalate, polyester, acrylic, aramid, polytetrafluoroethylene, polyamide, polyurethane and neoprene and/or man-made fibres selected from the group consisting of: fibres of cellulose, preferably viscose and/or Lyocell, cellulose acetate, cellulose triacetate, Cupro, or a combination thereof.

According to one embodiment of the present invention, said polymeric fibres are preferably selected from the group consisting of fibres of: polyester, one-component polyolefins, preferably polypropylene and/or polyethylene, two-component polyolefins, polyamide, neoprene, polyethylene terephthalate, polyvinyl alcohol, cellulose and thermoplastic cellulose derivatives, polyhydroxy alkanoates, polybutylsuccinates and a combination thereof.

More preferably, said polymeric fibres are selected from the group consisting of fibres of: polylactic acid (PLA), polyethylene terephthalate (PET), polypropylene (PP), polyethylene (PE), polyvinyl alcohol (PVA), and a combination thereof.

According to one embodiment, the process according to the present invention comprises, prior to step (iii) or step (iv′), a step (iia) of treating the discontinuous fibres and/or the polymeric fibres with a solution comprising compatibilizing agents and/or binders preferably selected from: epoxidized linseed oil, maleic anhydride, maleic anhydride-modified polypropylene, vegetable waxes, acetic anhydride, propionic anhydride, acrylic polymers, natural or synthetic esters, polyvinyl alcohol and a combination thereof.

According to an alternative embodiment, or in addition to the previous one, the process according to the present invention comprises, before or after step (iii) or (iv′), a step (iia′) of treating the non-woven fabric or the sliver with a solution comprising compatibilizing agents and/or binders preferably selected from: epoxidized linseed oil, maleic anhydride, maleic anhydride-modified polypropylene, acrylic polymers, natural or synthetic esters and a combination thereof. Said treatment of step (iia) or (iia′) is preferably performed by means of a spray and/or dip coating technique.

According to one embodiment, step (iii) or (iv′) of the process according to the present invention is carried out at a temperature between 70 and 200° C.

According to one embodiment, step (iv) or (v′) of the process according to the present invention, is carried out at a temperature between 60 and 210° C.

Preferably, said temperature is the temperature of the head of the aforesaid funnel.

The subject matter of the present invention also relates to granules comprising discontinuous fibres in a polymer matrix or in at least one binder, obtainable according to the process according to any one of the above-described embodiments.

Said granules are characterized by having:
a residual moisture, measured by placing said granules in a ventilated oven for 20 minutes at 120° C., ≤6%, preferably ≤4%, more preferably ≤2%;
apparent density ≥0.10 g/cm³, preferably ≥0.15 g/cm³.

According to the embodiment wherein said granules comprise discontinuous fibres in a polymer matrix, said granules are also characterized in that said polymer matrix is a polymer matrix resulting from the fusion, during the condensation step (iv), of the polymeric fibres of step (i).

Without wishing to be bound to a specific theory, the Applicant has found that, thanks to steps (i)-(v) or (i′)-(vi′) of the process according to the present invention, as described above, it is possible to obtain the aforesaid granules comprising discontinuous fibres (natural and/or synthetic and/or man-made) that advantageously have extremely reduced residual moisture values, i.e. residual moisture values, measured by placing said granules in a ventilated oven for 20 minutes at 120° C., ≤6%, preferably ≤4%, more preferably ≤2%.

The process according to the present invention thus enables an effective and efficacious inclusion of discontinuous fibres (natural and/or synthetic and/or man-made) within plastic materials, resulting in eco-sustainable fibre-reinforced composite plastic materials having the desired improved mechanical properties (due to the reinforcement action of the discontinuous fibres), but without the disadvantages tied to degradation due to excessively high residual moisture values of the fibres.

In addition, the granules obtainable with the process according to the present invention are characterized by having an apparent density ≥0.10 g/cm³, preferably ≥0.15 g/cm³, making them in fact effectively compatible with traditional plastic production processes and effectively overcoming the disadvantages tied to the use of discontinuous fibres, which notoriously have a low density and are therefore difficult to dose and disadvantageous with respect to industrial processes.

The subject matter of the present invention also relates to a fibre-reinforced composite plastic material obtainable by means of a process comprising the steps of:
(a) providing the granules comprising discontinuous fibres in a polymer matrix or in at least one binder as described above and obtainable with the process according to the present invention;
(b) adding said granules inside an extruder or an injection moulding machine comprising the polymer or polymers to be processed until a composite plastic material comprising, dispersed therein, said discontinuous fibres is obtained.

According to the embodiment wherein said granules comprise discontinuous fibres in a polymer matrix, said polymer matrix of the granules and the polymer/polymers used to produce the plastic material are preferably the same material and said polymer matrix is perfectly fused and indistinguishable within the final fibre-reinforced composite plastic material.

Said polymer matrix and said polymer/said polymers to be processed are selected from the group consisting of:

polyester, one-component polyolefins, preferably polypropylene and/or polyethylene, two-component polyolefins, polyamide, neoprene, polyethylene terephthalate, polyvinyl alcohol, cellulose and thermoplastic cellulose derivatives, polyhydroxy alkanoates, polybutylsuccinates and a combination thereof.

More preferably, said polymer matrix and said polymer/said polymers to be processed are selected from the group consisting of fibres of: polylactic acid (PLA), polyethylene terephthalate (PET), polypropylene (PP), polyethylene (PE), polyvinyl alcohol (PVA), and a combination thereof Without wishing to be bound to a specific theory, the Applicant has found that it is particularly advantageous to select the aforesaid starting polymeric fibres (i.e. “sacrificial fibres”) that are of the same material as the polymer/polymers to which the granules obtained with the process according to the present invention will be added for the production of a fibre-reinforced composite plastic material. As already noted, during the process according to the present invention (steps (i)-(v)) the aforesaid polymeric fibres will be fused to form a polymer matrix comprising therein the discontinuous fibres. Such a structure of the granules ensures that, once the latter are added to the polymer/polymers to be processed to form the final plastic material, that plastic matrix, being of the same material, will be perfectly fused and indistinguishable within the final plastic material, thus resulting in the obtainment of a fibre-reinforced composite plastic material, i.e. one comprising discontinuous fibres dispersed therein.

### EXAMPLES

### Example 1

A mixture containing 50% by weight of PLA fibres (60 mm, 3 denier) and 50% by weight of bamboo fibres (60 mm) is introduced inside an opening machine. The fibres thus prepared are subsequently inserted into a carder with a width of 340 mm, operating at a speed of 6 m/min (corresponding to the speed of the non-woven fabric produced). The non-woven fabric resulting from the carding process (15 g/m²) is transferred into an electric hot air oven at a temperature of 180° C., with the same line speed as indicated above. Upon exiting the oven, the non-woven fabric is conveyed inside a condenser having the following operating parameters:
Head temperature: 185° C.
Roller speed: 6 m/min
Gap between the cylinders: 1.9 mm.

Upon exiting the condenser, the final product is in the form of a cord that is cut into granules by a rotating cutter operating at the same line speed (6 m/min). The granules thus obtained have a residual moisture of 3.7%, measured by putting the product in a ventilated oven for 20 minutes at 120° C., and an apparent density of 0.16 g/cm³.

Said granules are collected in order to be subsequently fed into a twin-screw or single-screw extruder by means of a gravimetric or volumetric dosing unit in order to obtain the fibre-reinforced composite plastic material according to the present invention.

### Example 2

The same operations as described in Example 1 are repeated using the following fibre composition: 70% by weight of bamboo fibres (60 mm) and 30% by weight of PLA fibres (60 mm, 3 denier).

The granules obtained have a residual moisture of 3.9%, measured by putting the product in a ventilated oven for 20 minutes at 120° C., and an apparent density of 0.17 g/cm³.

### Example 3

The same operations as described in Example 1 are repeated using the following fibre composition: 50% by weight of PLA fibres (60 mm, 3 denier) and 50% by weight of flax fibres (60 mm);

The granules obtained have a residual moisture of 4.3%, measured by putting the product in a ventilated oven for 20 minutes at 120° C., and an apparent density of 0.17 g/cm³.

### Example 4

The same operations as described in Example 1 are repeated using the following fibre composition: 50% by weight of PLA fibres (60 mm, 3 denier) and 50% by weight of hemp fibres (60 mm);

The granules obtained have a residual moisture of 4.2%, measured by putting the product in a ventilated oven for 20 minutes at 120° C., and an apparent density of 0.18 g/cm³.

### Example 5

The same operations as described in Example 1 are repeated using the following fibre composition: 50% by weight of fibres of PE (60 mm, 4 denier) and 50% by weight of bamboo fibres (60 mm).

Compared to the process described in Example 1, the electric oven temperature is set at 130° C. and the condenser head temperature is set at 140° C.

The granules obtained have a residual moisture of 3.1%, measured by putting the product in a ventilated oven for 20 minutes at 120° C., and an apparent density of 0.16 g/cm³.

### Example 6

The same operations as described in Example 1 are repeated using the following fibre composition: 50% by weight of PP fibres (60 mm, 4 denier) and 50% by weight of bamboo fibres (60 mm).

Compared to the process described in Example 1, the condenser head temperature is set at 190° C.

The granules obtained have a residual moisture of 2.9%, measured by putting the product in a ventilated oven for 20 minutes at 120° C., and an apparent density of 0.16 g/cm³.

### Example 7

The same operations as described in Example 6 are repeated with the addition of a step in which the non-woven fabric, upon exiting the carder and before being introduced into the electric oven, is sprayed with maleic anhydride-modified polypropylene (AUSER POLIMERI, COMPOLINE CO/PP H60) in a liquid state by means of a heat gun.

The granules obtained have a residual moisture of 3%, measured by putting the product in a ventilated oven for 20 minutes at 120° C., and an apparent density of 0.16 g/cm³.

### Example 8

The same operations as described in Example 6 are repeated with the addition of a step in which the non-woven fabric, upon exiting the electric oven (before the condenser), is sprayed with maleic anhydride-modified polypropylene (AUSER POLIMERI, COMPOLINE CO/PP H60) in a liquid state by means of a heat gun.

The granules obtained have a residual moisture of 2.9%, measured by putting the product in a ventilated oven for 20 minutes at 120° C., and an apparent density of 0.17 g/cm³.

### Example 9

The same operations as described in Example 6 are repeated with the addition of a step in which the non-woven fabric, upon exiting the carder and before being introduced into the electric oven, is sprayed with epoxidized linseed oil (TARQUISA) in a liquid state by means of a heat gun.

The granules obtained have a residual moisture of 2.8%, measured by putting the product in a ventilated oven for 20 minutes at 120° C., and an apparent density of 0.16 g/cm³.

1. A process for producing granules comprising discontinuous fibres in a polymer matrix, said process comprising the steps of:
(i) Providing a mixture of discontinuous fibres and polymeric fibres:
(ii) Subjecting said discontinuous fibres and said polymeric fibres to a carding process until a non-woven fabric or a sliver is obtained:
(iii) Subjecting said non-woven fabric or said sliver to heat treatment:
(iv) Subjecting said non-woven fabric or said sliver obtained after step (iii) to a condensation process wherein said non-woven fabric or said sliver is conveyed inside a temperature controlled funnel at the exit of which it is pressed inside a template, to form a cord or passing the non-woven fabric or the sliver through a twisting process, to obtain a cord:
(v) Cutting said cord obtained after step (iv) into granules.

2. A process for producing granules comprising discontinuous fibres in at least one binder selected from the group consisting of: vegetable waxes, animal waxes, mineral waxes, polyvinyl alcohol (PVA), cellulose acetate, vinyl acetate, ethyl cellulose, ethylvinyl alcohol, starch, casein, animal gelatine, egg white, egg yolk, bitumen, solid terpenes, and a combination thereof, said process comprising the steps of:
(i′) Providing discontinuous fibres:
(ii′) Subjecting said discontinuous fibres to a carding process until a non-woven fabric or a sliver is obtained;
(iii′) Treating said non-woven fabric or said sliver with said at least one binder by spray coating, dip coating and/or moulding techniques:
(iv′) Subjecting said non-woven fabric or said sliver to heat treatment:
(v′) Subjecting said non-woven fabric or said sliver obtained after step (iv′) to a condensation process wherein said non-woven fabric or said sliver is conveyed inside a temperature controlled funnel at the exit of which it is pressed inside a template, to form a cord or passing the non-woven fabric or the sliver through a twisting process, to obtain a cord;
(vi) Cutting said cord obtained after step (v″) into granules.

3. The process according to claim 2, wherein step (v′) is performed between steps (ii′) and (iii′).

4. The process according to claim 1, wherein the mixture of step (i) or the non-woven fabric or the sliver of step (iii′) comprises said discontinuous fibres in an amount ≥50% by weight.

5. The process according to claim 1, wherein the mixture of step (i) comprises said polymeric fibres in an amount ≤50% by weight.

6. The process according to claim 2, wherein in step (iii′) said at least one binder is employed in an amount of from 1 to 30%.

7. The process according to claim 1, wherein said discontinuous fibres are selected from the group consisting of cotton, hemp, bamboo, linen, coconut, polypropylene, polyethylene, polyethylene terephthalate, polyester, acrylic, aramid, polytetrafluoroethylene, polyamide, polyurethane and neoprene and cellulose fibres, or a combination thereof.

8. The process according to claim 1, wherein said polymeric fibres are selected from the group consisting of fibres of: polyester, one-component polyolefins, two-component polyolefins, polyamide, neoprene, polyethylene terephthalate, polyvinyl alcohol, cellulose and thermoplastic cellulose derivatives, polyhydroxy alkanoates, polybutylsuccinates and a combination thereof.

9. The process according to claim 1 further comprising, prior to step (ii) or (ii′), a step (iia) of treating the discontinuous fibres with or without polymeric fibres with compatibilizing agents.

10. The process according to claim 1 further comprising, before or after step (iii) or (iv′), a step (iia′) of treating the non-woven fabric or the sliver with a solution comprising compatibilizing agents and/or binders.

11. The process according to claim 1, wherein step (iii) or (iv′) is carried out at a temperature between 70 and 200° C.

12. The process according to claim 1, wherein the condensation step (iv) or (v′) is carried out at a temperature between 60 and 210° C.

13. Granules comprising discontinuous fibres in a polymer matrix or in at least one binder obtainable according to the process according to claim 1, wherein said granules are characterized by having:
a residual moisture content ≤6%,
apparent density ≥0.10 g/cm³.

14. The Granules according to claim 13, wherein said granules comprise discontinuous fibres in a polymer matrix and are characterized in that said polymer matrix is a polymer matrix resulting from the fusion, during the condensation step (iv), of the polymeric fibres of step (i).

15. Fibre-reinforced composite plastic material obtainable by a process comprising the steps of:
(a) Providing granules comprising discontinuous fibres in a polymer matrix or in at least one binder according to claim 13;
(b) Adding said granules inside an extruder or an injection moulding machine comprising the polymer to be processed until a composite plastic material comprising, dispersed therein, said discontinuous fibres is obtained.

16. The-Fibre-reinforced composite plastic material according to claim 15, wherein step (a) is a step of providing granules comprising discontinuous fibres in a polymer matrix, and wherein step (b) is characterized in that the polymer matrix of the granules and the polymer used to make the plastic material are the same material and said polymer matrix is perfectly fused and indistinguishable within the final fibre-reinforced composite plastic material.

17. The process according to claim 1, wherein the granules have the dimension of the major axis between 5 and 40 mm, the dimension of the cross-sectional between 1 and 20 mm and the dimension of the height between 0.5 and 10 mm.

18. The process according to claim 2, wherein the granules have the dimension of the major axis between 5 and 40 mm, the dimension of the cross-section between 1 and 20 mm and the dimension of the height between 0.5 and 10 mm.
